(19) United States
(12) Patent Application Publication
(10) Pub. No.: US 2023/0329228 A1
(43) Pub. Date: Oct. 19, 2023

(54) TURKEY TAIL FAN HUNTING DECOY POWERED BY AIR MOVEMENT

(71) Applicant: KENT JACKSON DORTON, JR., MELROSE, FL (US)

(72) Inventor: KENT JACKSON DORTON, JR., MELROSE, FL (US)

(73) Assignee: KENT JACKSON DORTON, JR., MELROSE, FL (US)

(21) Appl. No.: 17/833,327

(22) Filed: Jun. 6, 2022

Related U.S. Application Data
(60) Provisional application No. 63/332,093, filed on Apr. 18, 2022.

(51) Int. Cl. A01M 31/06

(52) U.S. Cl. CPC A01M 31/06

(57) ABSTRACT

A mechanism powered by air movement displaying a real or artificial turkey tail fan as a hunting decoy is disclosed herein. The mechanism encapsulates a turkey tail fan on a stake which is inserted into the ground. The turkey tail fan is subsequently rotated by air movement and is designed in such a manner as to return to its original position when air movement decreases or ceases without the aid of springs, strings, elastics, or other mechanized systems or equipment. This invention mimics the strutting display of the male wild turkey used as a means of communication during mating and dominance displays. Alternatively, the mechanism can be attached to full body strutting turkey decoys using mounting hardware provided with said full body decoys. This configuration provides increased decoy motion from air movement and significantly increases durability and lifespan of real turkey tail fans used in said application.

### CROSS REFERENCE TO RELATED APPLICATION

This application claims the benefit of Provisional Patent Application No. 63/332,093. File on Apr. 18, 2022.

### BACKGROUND OF THE INVENTION

There have been several disclosures of turkey hunting decoys, both turkey tail fan on a stake and full body decoys, that provide static or animated turkey tail fan displays. All of these turkey hunting decoys are either sedentary, mechanically operated, manually controlled, or fitted loosely together in such a manner as to allow motion controlled by wind. Sedentary designs provide very limited or no active motion, relying on static replication of a wild turkey for attraction. Mechanically operated turkey hunting decoys rely on mechanized systems that may often require a source of electrical power, are unnecessarily complex, and are unlawful in many regions where harvesting a wild turkey is permitted. Manually controlled turkey hunting decoys must be operated manually by the user. Manual control may be achieved either by direct physical interaction such as hand manipulation, by remote control such as cordage and pulleys, or varied other such apparatus. Manual operation is capable of providing realistic decoy motion but often produce undesirable and unnatural secondary movement of the operator or motion mechanism that can alarm wild turkey rendering such operation ineffective. Previous wind powered turkey hunting decoys provide attractive motion without secondary movement from the operator or mechanisms, but rely solely on the movement, speed, and direction of wind. This dependency on wind movement, speed, and direction can result in negative effects such as displaying the turkey hunting decoy in an unintended and improper direction or spinning unnaturally in adverse or high wind conditions. These unnatural movements caused by wind direction and speed are also undesirable, resulting in alarming or alerting the intended subject.

U.S. Pat. No. 7,784,213 B1 discloses a full body strutting turkey decoy with a real or artificial turkey tall fan attached to the body of the decoy. This turkey hunting decoy functions as a static or sedentary representation of a male wild turkey and includes a folding mounting system designed to receive individual turkey tail feathers for a more realistic lifelike representation of a turkey tail fan that is then connected to the full body turkey hunting decoy. Sedentary use of this turkey hunting decoy provides very limited or no active motion reducing the efficacy of the decoy and relying solely on a detailed lifelike representation of a male wild turkey.

US Patent No. 2012/0042561 A1 discloses a movable turkey tail fan decoy that is mounted on a stake which is inserted into the ground or connected directly to a full body strutting turkey decoy. This turkey hunting decoy relies on remote operation to produce movement. Movement is produced by pulling on a string attached to an artificial or real turkey tail fan that is opposed by a spring connecting the turkey tail fan to the stake or full body strutting turkey decoy. This manual operation raises and lowers the turkey tail fan mimicking the strutting display of a male turkey. This remote operation can result in unnatural secondary movement of the operator or mechanism potentially alarming game also reducing the efficacy of the decoy.

U.S. Pat. No. 8,191,304 B2 discloses a full body, collapsible strutting turkey decoy. This decoy collapses to a smaller size for transport and is intended to rotate freely wind/air touch. As previously stated, this type of turkey hunting decoy is dependent on the direction and speed of the wind or air influencing it. Such dependency can result in negative effects such as displaying in an improper direction or spinning unnaturally.

### SUMMARY OF THE INVENTION

The present invention allows for increased realistic motion of a turkey tail fan on a stake decoy by using only wind or air movement when deployed independently on a stake, eliminating the need for hand or mechanical manipulation to operate. The present invention is believed to produce realistic or attractive movements powered only by wind or air movement without spinning uncontrollably and or facing in a direction not intended at the time of the decoy placement. Realistic motion and returning to the original intended direction of presentation is accomplished through mounting the decoy on the stake in an off of center location resulting in an uneven distribution of weight. An uneven distribution of weight produces a slight lean when the stake is inserted into the ground. Uneven weight distribution, culminating in a leaning condition, biased against gravity creates resistance preventing uncontrolled spinning in high wind conditions and assisting the present invention in returning to the original intended direction of decoy placement when air movement decreases or ceases. The present invention can also be mounted or attached to full body strutting turkey decoys using common methods of attachment. In this configuration the present invention completely encapsulates and provides increased support to all structural parts of the real or artificial turkey tail fan. The increased support of the turkey tail fan provided by the present invention in this configuration also produces increased movement of full body strutting decoys and protection in wind, rain, and during repeated field use.

### BRIEF DESCRIPTION OF DRAWINGS

FIG. 1 illustrates the present invention in a completely disassembled state.

FIG. 2 illustrates the side view of the main body (1) of the present invention.

FIG. 3 illustrates the bottom view of the main body (1) of the present invention.

FIG. 4 illustrates the present invention with a real or artificial turkey tail fan secured between the main body (1) and the rear closure and support bracket (2). The assembled unit is depicted off of the stake (3) as would be used for transport or storage.

FIG. 5 illustrates the present invention fully assembled with real or artificial turkey tail fan deployed on a stake for independent use in the field.

FIG. 6 illustrates the assembled unit attached to a full body strutting turkey decoy.

### DETAILED DESCRIPTION OF THE PRESENT INVENTION

Disclosed herein are examples of the present invention. The disclosed examples are not intended to limit the present invention to the specific embodiments either described or illustrated in this disclosure.

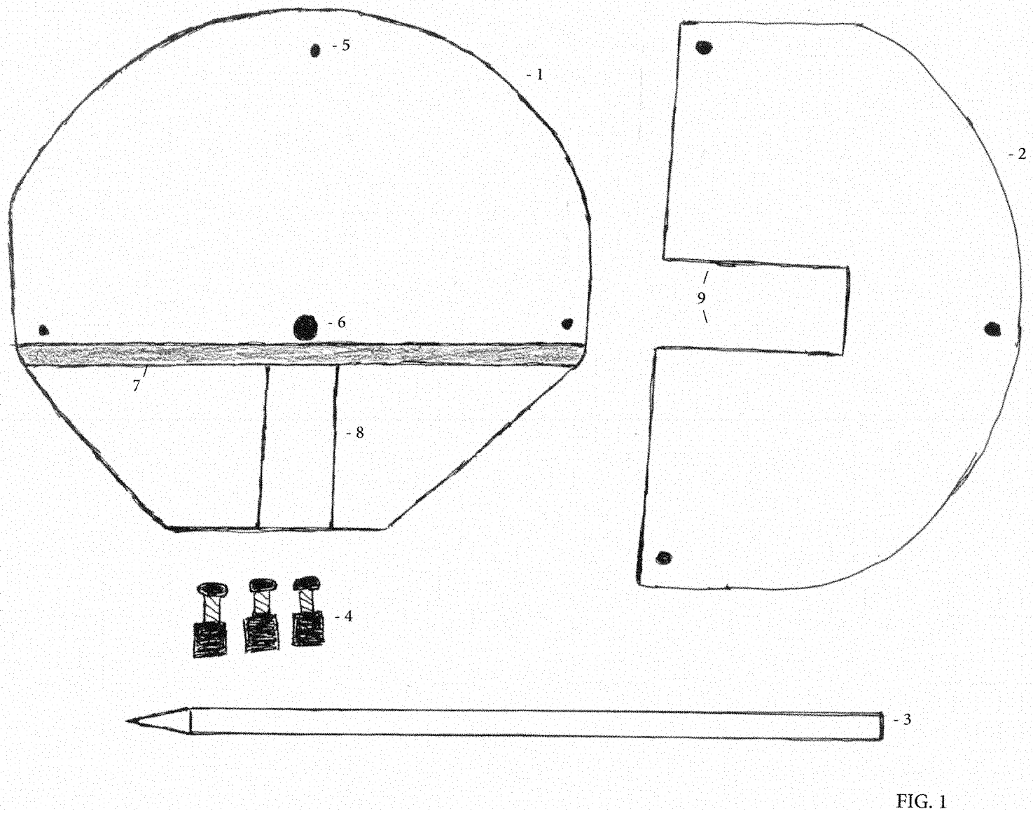

FIG. 1 illustrates the disassembled view of the present invention and details associated components of a preferred embodiment of the invention. The main body (1) may be constructed from various composites, plastics, fiberglass, wood types, metals, or other such durable materials. The main body (1) may vary in size, both vertically and horizontally, from four to fourteen inches or as would be appropriate to match the prospective sizes of artificial turkey tail fans or the tail fans of the individual subspecies of the wild turkey being targeted with this invention. The chosen construction material of the main body (1) may be formed from one millimeter to one inch thick as appropriate to provide support and stability for a real or artificial turkey tail fan chosen for use with this invention. The main body (1) may be formed in such a way as to include a supporting shelf (7). The supporting shelf (7) may vary in width from one eighth inch to two inches, may vary in length from one to fourteen inches, and be located at, above or below the center line of the main body (1). The main body (1) may include fastener receptacles (5) appropriate to the chosen method of connection. The main body (1) should include a strutting decoy mounting receptacle (6), and a stake insert receptacle (8) of appropriate size to receive and be mounted upon the stake (3). The stake insert receptacle (8) should be formed off of the center line of the main body (1) as to produce an uneven weight distribution when fully assembled with the chosen real or artificial turkey tail fan. The stake (3) may be constructed from various composites, plastics, wood types, metals, or other such durable materials, vary in diameter from one eighth to two inches and length from four to forty-eight inches. The stake (3) may be of solid or tubular construction. The stake (3) may be of equal diameter at both ends or be tapered in such a manner as to facilitate insertion into substrate. The rear closure and supporting bracket (2) may be constructed from various composites, plastics, wood types, metals, or other such durable materials and include a tail fan cut out (9). The rear closure and supporting bracket (2) may vary in height from two to eight inches, width from four to fourteen inches, and diameter from one millimeter to one inch thick as to mate to the main body (1). The tail fan cut out (9) may vary in height and width from one to five inches and be of appropriate shape to accommodate the supporting structures of the real of artificial turkey tail fan chosen for use with the present invention. The rear closure and supporting bracket (2) may also include fastener receptacles (5) as appropriate to match and connect to the main body (1). Fasteners (4) are depicted as but not limited to screw/bolt and nut securement of the rear closure and supporting bracket (2) to the main body (1).

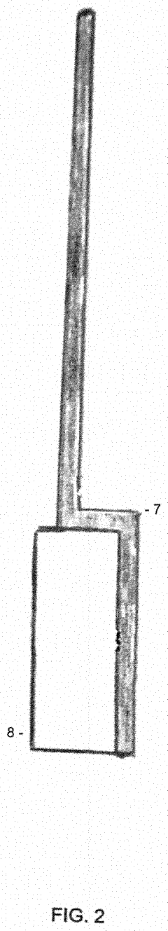

FIG. 2 illustrates the side view of the main body (1) and the approximate locations of the supporting shelf (7) and the stake insert receptacle (8). All previously described measurements of height, width, diameter and thickness are applicable to this illustration.

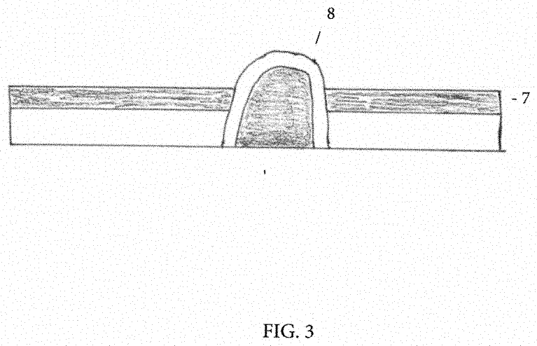

FIG. 3 illustrates the bottom view of the main body (1) and the approximate locations of the supporting shelf (7) and the stake insert receptacle (8). All previously described measurements of height, width, diameter and thickness are applicable to this illustration.

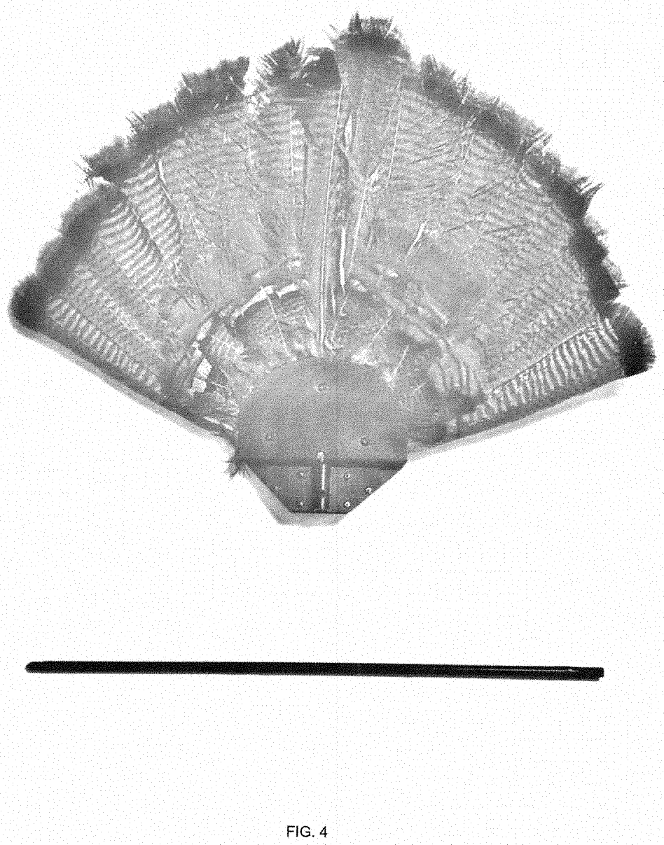

FIG. 4 illustrates the present invention with a real or artificial turkey tail fan secured between the main body (1) and the rear closure and supporting bracket (2). The real or artificial turkey tail fan may be secured between the main body (1) and the rear closure and supporting bracket (2) using the depicted screw/bolt and nut type fasteners, machine or wood screws, rivets, hook and loop type systems, adhesives, welds, or magnetism.

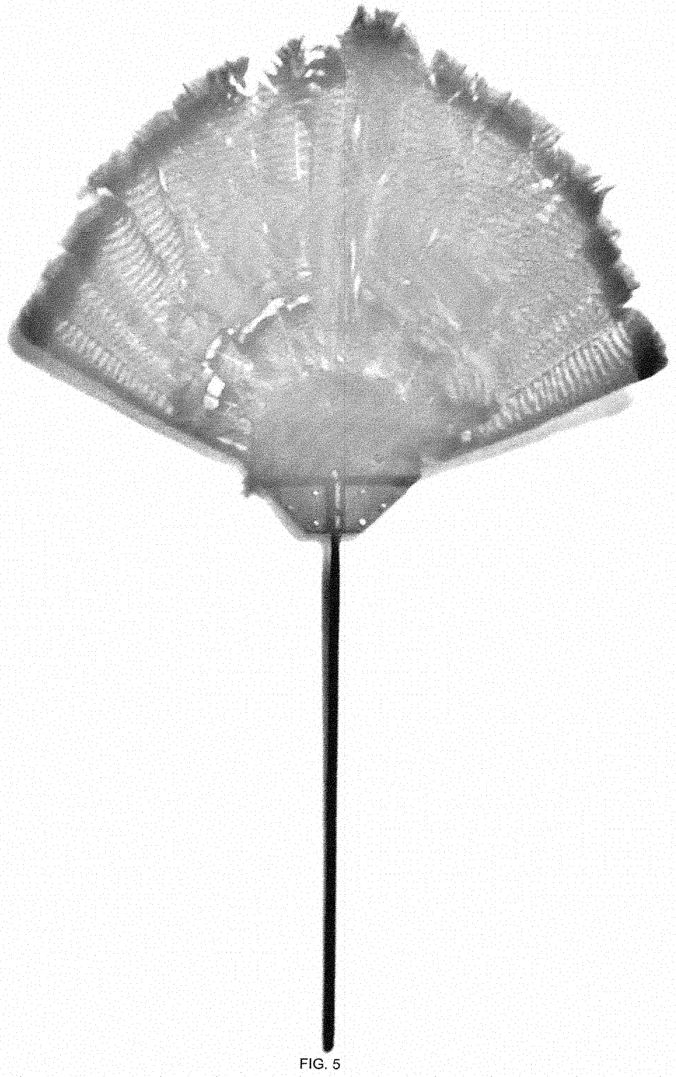

FIG. 5 illustrates the present invention fully assembled with a real or artificial turkey tail fan mounted between the main body (1) and the rear closure and supporting bracket (2) then mounted on the stake (3) as would be deployed for use in the field. All previously described methods of connection and measurements of height, width, diameter and thickness are applicable to this illustration.

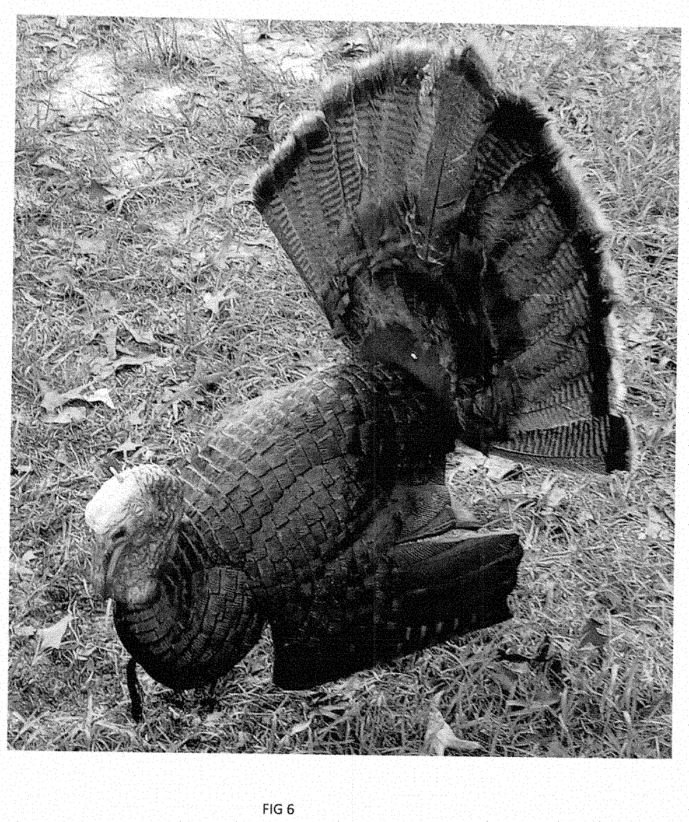

FIG. 6 illustrates the present invention attached to a full body strutting turkey decoy. The illustrated attachment is accomplished by connecting the mounting hardware provided with the strutting turkey decoy to the present invention using the strutting decoy mounting receptacle (6).

The present invention is claimed as follows:

1. A mounting system for use of an artificial or real turkey tail fan as a hunting decoy comprising of a main body (1), rear closure and support bracket (2), and stake (3) for display with lifelike motion produced only by wind or air movement biased by gravity with no hand or mechanical manipulation. Wherein said main body (1) shall be formed to include stake receptacle (8) in an off of center location to produce uneven weight distribution when fully assembled with an artificial or real turkey tail fan and mounted on a stake (3) for display or use as an independent turkey hunting decoy in the field. Uneven weight distribution, culminating in a leaning condition of the present invention, biased against gravity creates resistance preventing uncontrolled spinning in high wind conditions and assisting the present invention in returning to the original intended direction of decoy placement when air movement decreases or ceases.

2. A mounting system as in claim 1 wherein said main body (1), rear closure and support bracket (2), and stake (3) can be made in varying sizes as previously stated and connected in previously described manners to facilitate support for an artificial or real turkey tail fan and accurately replicate the sizes and height of the different individual subspecies of wild turkey.

3. A mounting system as in claim 1, wherein the main body (1), rear closure and support bracket (2), and stake (3) can be made of various composites, plastics, metal, wood, or other durable material; may be hollow or solid, of varying and sufficient diameter to fit the stake insert tube and vary in length and taper as required by the prospective terrain deployed in.

4. A mounting system as in claim 1, that when fully assembled may be deployed independently as an individual turkey hunting decoy on a stake, or attached to a full body strutting turkey decoy using the strutting decoy mounting receptacle (6).
